(19) United States
(12) Patent Application Publication
(10) Pub. No.: US 2016/0217713 A1
(43) Pub. Date: Jul. 28, 2016

(54) BEVERAGE IDENTIFICATION MARKER WITH MATCHING WEARABLE IDENTIFIERS

(71) Applicant: Kimberly C. Kranker, Medfield, MA (US)

(72) Inventor: Kimberly C. Kranker, Medfield, MA (US)

(21) Appl. No.: 15/007,824

(22) Filed: Jan. 27, 2016

Related U.S. Application Data
(60) Provisional application No. 62/108,975, filed on Jan. 28, 2015.

(51) Int. Cl. G09F 3/02; G09F 3/00

(52) U.S. Cl. CPC G09F 3/02; G09F 3/005; G09F 2003/0251

(57) ABSTRACT

A beverage identification system includes a beverage identification marker and a wearable identifier paired to the beverage identification marker. The beverage identification marker and wearable identifier each include a same or similar visual marking, such as a pattern, a color, a shape, a size, a texture, a material, or a combination thereof.

### RELATED APPLICATION

This application claims the benefit of U.S. Provisional Application No. 62/108,975, filed on 28 Jan. 2015. The entire teachings of the above application(s) are incorporated herein by reference.

### BACKGROUND

Beverage identification markers are typically provided to place on individuals' beverage containers to identify and help differentiate one's beverage from another. This requires each individual to remember the specific markings that were assigned to their beverage container. There have been some attempts at making the identification of a container easier. For example, printable labels to identify a beverage container and special markers to write on a beverage container have been described. These inventions are cumbersome to use and still require individuals to remember some part of the design, or the beverage container identification is too easily removed.

### SUMMARY OF THE INVENTION

Described is a beverage identification system, which includes a beverage identification marker and a paired wearable identifier. A beverage identification marker attaches to a beverage container and a wearable identifier is worn on a person. The wearable identifier includes a visual marking that is the same or similar to a visual marking included on the beverage identification marker. The visual marking can be a pattern, color, shape, size, texture, material, or any combination thereof.

The combination of the beverage identification marker and the wearable identifier allows the individual to identify which beverage is theirs by simply matching their wearable identifier with that attached to the beverage container. The beverage identification system enables a person to locate their beverage container even if they have forgotten the appearance of their beverage marker.

Alternatively, a beverage identification system includes at least two pairs of identifiers, each pair of identifiers including a beverage identification marker and a wearable identifier, and each pair having a distinguishable appearance from each other pair of identifiers. The beverage identification marker of a pair can include a visual marking that is the same or similar to a visual marking included on the wearable identifier of the pair. Each pair includes a different visual marking from each other pair of identifiers.

A method of identifying a beverage includes placing a beverage identification marker on the beverage and wearing an identifier paired to the beverage identification marker. Wearing an identifier can include placing the identifier about a wrist or clipping the identifier to an article of clothing. Placing the identification marker includes securely attaching it to a beverage container.

A kit includes a package and at least two pairs of identifiers in the package, each pair of identifiers including a beverage identification marker and a wearable identifier. Each pair has a distinguishable appearance from each other pair of identifiers.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates a beverage identification marker and a wearable identifier.

FIG. 2 illustrates the beverage identification marker of FIG. 1 with a second type of wearable identifier.

FIG. 3 illustrates a beverage identification marker on a different type of container and a wearable identifier.

FIG. 4 illustrates a beverage identification marker and a wearable identifier attached to a different clothing location.

FIG. 5 illustrates a set of beverage identification markers and wearable identifiers included in a package.

### DETAILED DESCRIPTION OF THE INVENTION

A description of example embodiments of the invention follows.

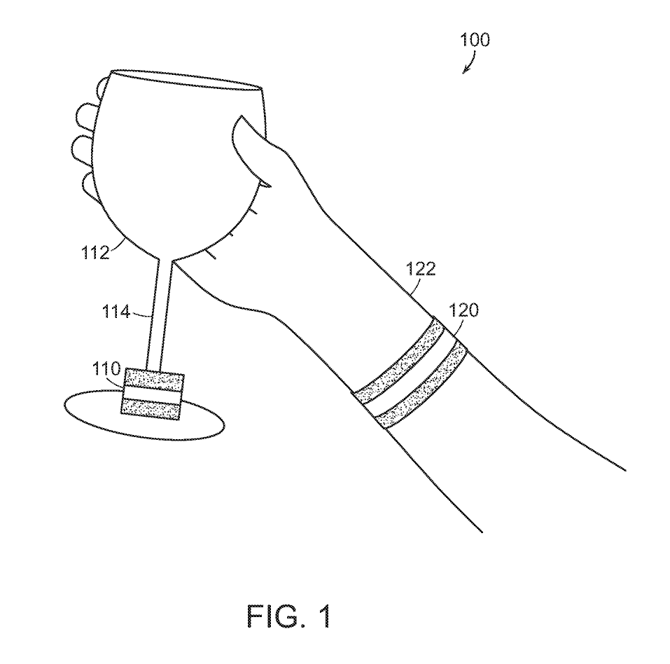

As shown in FIG. 1, a beverage identification system 100 includes a beverage identification marker 110 and a corresponding, matching wearable identifier 120. Beverage identification marker 110 is attached to a beverage container 112. In particular, beverage identification marker 110 is shown to circumscribe the stem 114 of a wine glass 112. Matching wearable identifier 120 is shown worn on a wrist 122. Beverage identification marker 110 and matching wearable identifier 120 can each incorporate a recognizable color or design that indicates that they are paired. For example, as shown in FIG. 1, beverage identification marker 110 and matching wearable identifier 120 each display a striped design.

A beverage identification marker can be, for example, a closed loop of material that can be placed around the stem of a wine glass by threading the material over the base of the wine glass. Alternatively, a beverage identification marker can be an open loop of material that can be fit directly over the stem of a wineglass, or a strip of material that can be wound about the stem of a wineglass and affixed to itself, such as through a hook and loop, snap, magnet, button, elastic, or tie closure. When attached, the beverage identification marker has a diameter that is smaller than that of the base of the wine glass and/or the bowl of the wine glass, allowing it to stay attached during normal movement of the drink. The beverage identification marker can be easily removed from the wine glass for reuse at a later time.

A matching wearable identifier can be, for example, a loop of material that can be worn on the body. As shown in FIG. 1, matching wearable identifier 120 is worn as a wristband. Alternatively, a matching wearable identifier can be worn as a ring, anklet, or necklace. A matching wearable identifier can also be formed from a strip of material that can be wound about the wrist, or another other body part, or an open loop of material, such as a bracelet cuff, that can be fit directly over the wrist. The wearable identifier can be attached to the person, their clothing, or any accessory of the person in a manner that allows normal movement, but is easily removed for reuse at a later time.

Beverage identification markers and wearable identifiers can be, for example, closed or open bands of elastic, silicon, or other, similar flexible material. Alternatively, beverage identification markers and wearable identifiers can be material, such as ribbon, layered over a flexible spring band, such as a slap bracelet or snap bracelet. Other materials that can be used to form beverage identification markers and/or wearable identifiers, either alone or layered over a flexible spring band, include leather, lace, cloth, felt and other fabrics.

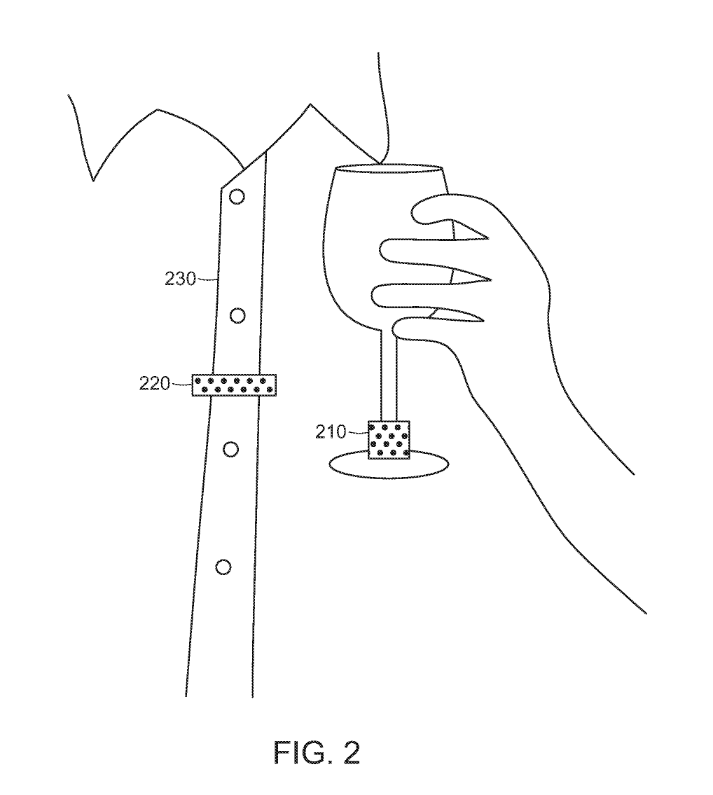

In an alternative configuration, as shown in FIG. 2, a wearable identifier 220 is worn on the placket 230 of a shirt and is paired with beverage identification marker 210. Wearable identifier 220 can be, for example, a clip, such as a tie clip, that can slide over and pinch tight against a clothing layer, allowing it to stay affixed to the clothing during normal movement. As shown in FIG. 2, wearable identifier 220 and beverage identification marker 210 are indicated as being paired by each having a similar or identical design, for example, a polka-dot pattern.

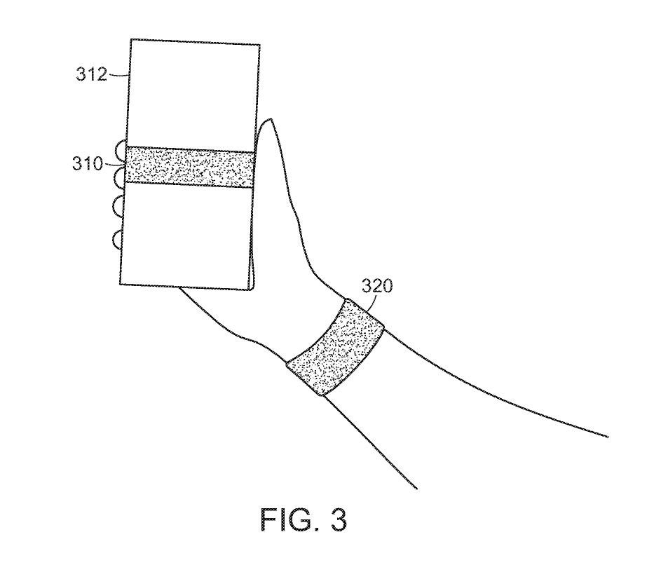

Beverage identification markers can conform to a variety of glass shapes and sizes. As shown in FIG. 3, a beverage identification marker 310 is attached to the walls of a cylindrical drinking glass 312. Beverage identification marker 310 can, for example, be a closed loop of material that is capable of staying affixed to the sides of the drinking glass, can, or bottle. Matching wearable identifier 320 is shown worn on the wrist, similar to wearable identifier 120 shown in FIG. 1. Beverage identification marker 310 and matching wearable identifier 320 are shown to be paired by having the same solid color. Beverage identification marker 310 and matching wearable identifier 320 can be similarly or identically sized bands of material, such that each band can be interchangeably worn on a body or on a beverage container. For example, beverage identification marker 310 and matching wearable identifier 320 can be identical bands of elastic material, or identical slap bracelets, which are capable of being worn both as a bracelet and of fitting around a drinking glass.

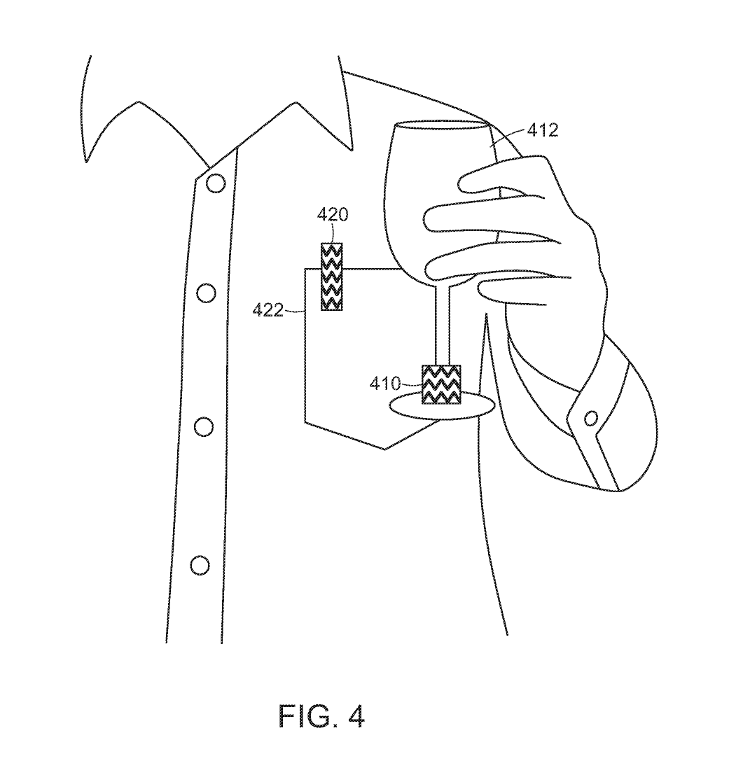

Wearable identifiers can also apply to a variety of different clothing types or at a variety of clothing locations. As shown in FIG. 4, a wearable identifier 420 is shown affixed to the pocket 422 of a shirt. Wearable identifier 420 can be a clip, such as that described with respect to wearable identifier 220. Wearable identifiers in a clip configuration can be worn on shirt plackets (as shown in FIG. 2), on shirt pockets (as shown in FIG. 4), on other shirt locations including cuffs, collars, and lapels, or on other articles of clothing, such as belts, belt loops, sneaker lacings, ankle straps, pant hems, and the like. Matching beverage identification marker 410 is shown affixed to the stem of a wine glass. Beverage identification marker 410 and matching wearable identifier 420 are shown to be paired by each including a matching design, for example, a chevron pattern.

The visual matching of a beverage identification marker to a wearable identifier can be accomplished by incorporating the same pattern, color, shape, size, texture, material, or any combination thereof in both the beverage marker and the wearable identifier. The distinct markings of an identification pair (a beverage marker and a wearable identifier), serve as a visual cue for a person to identify his or her beverage container from the beverage container(s) of another.

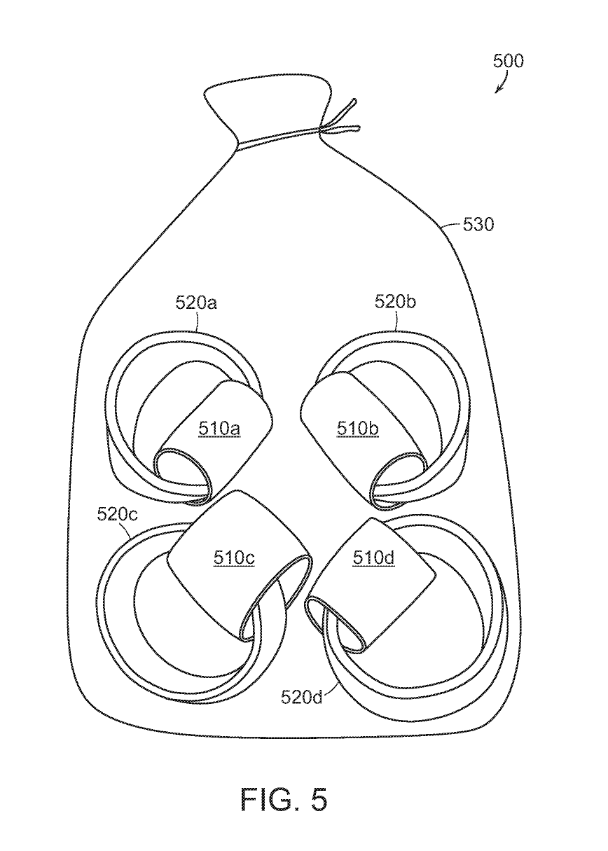

A beverage identification system can include multiple sets of paired beverage identification markers and matching wearable identifiers, with each pair incorporating a distinct pattern, color, shape, size, texture, material, or any combination thereof from the other pairs in the set. For example, a beverage identification system 500 is shown in FIG. 5. The system 500 includes four sets of markers and identifiers, with each beverage identification marker 510a, 510b, 510c, 510d linked together with a matching wearable identifier 520a, 520b, 520c, 520d. The marker and identifier sets are contained within a package 530, such as a bag or other container. While beverage identification system 500 is shown as having four sets of marker and identifier pairs, any number of marker and identifier sets can be included. For example, a beverage identification system can include 2, 3, 4, 5, 6, 8, 10, 12, or 20 marker and identifier sets.

Additionally, while sets are shown in FIG. 5 to include one wearable identifier paired to each beverage identification marker, a set can include multiple types of wearable identifiers paired to one beverage identification marker. For example, a set can include both a clip-type wearable identifier, such as wearable identifier 220 (FIG. 2), and a bracelet-type wearable identifier, such as wearable identifier 120 (FIG. 1), with both identifiers matching one beverage identification marker, thereby providing an individual with an option as to what type of identifier to wear for a corresponding marker. Alternatively, or in addition, multiple types of beverage identification markers can be included. For example, a set can include a wine glass-type beverage identification marker, such as marker 110 (FIG. 1), and a can-type beverage identification marker, such as marker 310 (FIG. 3), with both markers matching a wearable identifier.

The beverage identification markers and wearable identifiers can be used at gatherings where two or more people are using similar beverage containers and there is a need to differentiate between their containers.

While this invention has been particularly shown and described with references to example embodiments thereof, it will be understood by those skilled in the art that various changes in form and details may be made therein without departing from the scope of the invention encompassed by the appended claims.

What is claimed is:

1. A beverage identification system, comprising:
a beverage identification marker; and
a wearable identifier paired to the beverage identification marker.

2. The beverage identification system of claim 1, wherein the wearable identifier includes a visual marking that is the same or similar to a visual marking included on the beverage identification marker.

3. The beverage identification system of claim 2, wherein the visual marking is at least one of a pattern, a color, a shape, a size, a material, and a texture.

4. The beverage identification system of claim 2, wherein the visual marking is at least two of a pattern, a color, a shape, a size, a material, and a texture.

5. The beverage identification system of claim 1, wherein the beverage identification marker is an elastic band sized to securely attach to a beverage container.

6. The beverage identification system of claim 5, wherein the beverage container is a wine glass.

7. The beverage identification system of claim 5, wherein the beverage container is a cylindrical drinking glass.

8. The beverage identification system of claim 1, wherein the wearable identifier is a bracelet.

9. The beverage identification system of claim 1, wherein the wearable identifier is a clip.

10. A beverage identification system, comprising:
at least two pairs of identifiers, each pair of identifiers including a beverage identification marker and a wearable identifier, and each pair having a distinguishable appearance from each other pair of identifiers.

11. The beverage identification system of claim 10, wherein the beverage identification marker of a pair includes a visual marking that is the same or similar to a visual marking included on the wearable identifier of the pair, and wherein each pair includes a different visual marking from each other pair of identifiers.

12. The beverage identification system of claim 11, wherein the visual marking is at least one of a pattern, a color, a shape, a size, a material, and a texture.

13. The beverage identification system of claim 10, wherein the beverage identification marker is a band sized to securely attach to a beverage container.

14. The beverage identification system of claim 10, wherein the wearable identifier is a bracelet.

15. The beverage identification system of claim 10, wherein the wearable identifier is a clip.

16. A method of identifying a beverage, comprising:
placing a beverage identification marker on the beverage; and
wearing an identifier paired to the beverage identification marker.

17. The method of claim 16, wherein wearing an identifier includes placing the identifier about a wrist.

18. The method of claim 16, wherein wearing an identifier includes clipping the identifier to an article of clothing.

19. The method of claim 16, wherein placing the identification marker includes securely attaching it to a beverage container.

20. A kit, comprising:
a package; and
at least two pairs of identifiers in the package, each pair of identifiers including a beverage identification marker and a wearable identifier, and each pair having a distinguishable appearance from each other pair of identifiers.
